(19) United States
(12) Patent Application Publication
(10) Pub. No.: US 2025/0285084 A1
(43) Pub. Date: Sep. 11, 2025

(54) Reservation Assistance Device, Reservation Assistance Method, and Program

(71) Applicant: COMING SOON CoO., Ltd., Toshima-ku, Tokyo (JP)

(72) Inventor: Kazuhisa Washida, Toshima-ku, Tokyo (JP)

(21) Appl. No.: 18/860,351

(22) PCT Filed: Apr. 28, 2023
(86) PCT No.: PCT/JP2023/016904

§ 371 Date: Oct. 25, 2024

(30) Foreign Application Priority Data
Apr. 28, 2022 (WO) PCT/JP2022/019252

(51) Int. Cl. G06Q 10/1093

(52) U.S. Cl. CPC G06Q 10/1095

(57) ABSTRACT

A reservation assistance device includes: an obtaining unit configured to store status data indicating whether or not a reservation from a customer is acceptable for each of unit time periods and obtain a requested start time and a requested end time of the reservation requested by the customer; and a proposal unit that refers to the status data, and when the reservation is acceptable in a period from the requested start time to the requested end time and a difference time period between the requested start time and an end time of a reservation unacceptable time period immediately before the requested start time is equal to or larger than the unit time period and is less than a predetermined time period, outputs a proposal of changing the requested start time to the end time of the reservation unacceptable time period immediately before the requested start time, to the customer.

### CROSS-REFERENCE TO RELATED APPLICATION(S)

This application is a National Stage application under 35 U.S.C. § 371 of International Patent Application Serial No. PCT/JP2023/016904, filed Apr. 28, 2023, which claims priority to International Patent Application Serial No. PCT/JP2022/019252, filed Apr. 28, 2022, the entire disclosures of which is hereby incorporated by reference.

### TECHNICAL FIELD

The present invention relates to a reservation assistance device, a reservation assistance method, and a program.

### BACKGROUND

There is a device that optimizes a reservation schedule in a salon having multiple seats such as a beauty salon, a massage, or a nail salon (see Japanese Patent Application Publication No. 2007-156831). In Japanese Patent Application Publication No. 2007-156831, reservations whose reservation times are close to one another are grouped, and are rearranged in each group. Japanese Patent Application Publication No. 2007-156831 can optimize the reservations, and enables accepting of more reservations.

### SUMMARY

However, in Japanese Patent Application Publication No. 2007-156831, an in-between time period in which a new reservation is unacceptable occurs. Reducing the in-between time period enables accepting of more reservations.

The present invention has been made in view of the above circumstances, and an object of the present invention is to provide a technique that enables accepting of more reservations.

A reservation assistance device according to an aspect of the present invention includes: a storage device configured to store status data indicating whether or not a reservation from a customer is acceptable for each of unit time periods; an obtaining unit configured to obtain a requested start time and a requested end time of the reservation requested by the customer; and a proposal unit configured to refer to the status data, and when the reservation is acceptable in a period from the requested start time to the requested end time and a difference time period between the requested start time and an end time of a reservation unacceptable time period immediately before the requested start time is equal to or larger than the unit time period and is less than a predetermined time period, output a proposal of changing the requested start time to the end time of the reservation unacceptable time period immediately before the requested start time, to the customer.

A reservation assistance device according to another aspect of the present invention includes: a storage device configured to store status data indicating whether or not a reservation from a customer is acceptable for each of unit time periods; and a proposal unit configured to refer to the status data, and when a difference time period between a first time period in which the reservation is unacceptable and a second time period in which the reservation is unacceptable and that is immediately after the first time period is equal to or larger than the unit time period and is less than a predetermined time period, propose a change of the first time period or the second time period.

A reservation assistance device according to still another of the present invention includes: a storage device configured to store status data indicating whether or not a reservation from a customer is acceptable for each of unit time periods; an obtaining unit configured to obtain a requested time period of the reservation requested by the customer; and an identification unit configured to refer to the status data and identify, from among start candidate times at which the reservation of the requested time period is acceptable, the start candidate time at which a difference time period between the start candidate time and an end time of a reservation unacceptable time period immediately before the start candidate time is zero or equal to or more than a predetermined time period or a difference time period between a time at which the requested time period has elapsed from the start candidate time and a start time of the reservation unacceptable time period immediately after the time is zero or equal to or more than the predetermined time period; and a display unit configured to display the start candidate time identified by the identification unit, to the customer.

A reservation assistance method according to an aspect of the present invention includes: a computer stores status data indicating whether or not a reservation from a customer is acceptable for each of unit time periods; the computer obtains a requested start time and a requested end time of the reservation requested by the customer; and the computer refers to the status data, and when the reservation is acceptable in a period from the requested start time to the requested end time and a difference time period between the requested start time and an end time of a reservation unacceptable time period immediately before the requested start time is equal to or larger than the unit time period and is less than a predetermined time period, outputs a proposal of changing the requested start time to the end time of the reservation unacceptable time period immediately before the requested start time.

A reservation assistance method according to another aspect of the present invention includes: a computer stores status data indicating whether or not a reservation from a customer is acceptable for each of unit time periods; and the computer refers to the status data, and when a difference time period between a first time period in which the reservation is unacceptable and a second time period in which the reservation is unacceptable and that is immediately after the first time period is equal to or larger than the unit time period and is less than a predetermined time period, proposes a change of the first time period or the second time period.

A reservation assistance method according to still another aspect of the present invention includes: a computer stores status data indicating whether or not a reservation from a customer is acceptable for each of unit time periods; the computer obtains a requested time period of the reservation requested by the customer; and the computer refers to the status data and identifies, from among start candidate times at which the reservation of the requested time period is acceptable, the start candidate time at which a difference time period between the start candidate time and an end time of a reservation unacceptable time period immediately before the start candidate time is zero or equal to or more than a predetermined time period and a difference time period between a time at which the requested time period has elapsed from the start candidate time and a start time of the reservation unacceptable time period immediately after the time is zero or equal to or more than the predetermined time period; and causing the computer to display the identified start candidate time to the customer.

An aspect of the present invention is a program that causes a computer to function as the above reservation assistance.

The present invention can provide a technique that enables accepting of more reservations.

### BRIEF DESCRIPTION OF THE DRAWINGS

FIG. 1 is a diagram explaining a system configuration of a processing system and function blocks of a reservation assistance device according to an embodiment of the present invention;

FIG. 2 is an example of a status display screen displayed by the reservation assistance device;

FIG. 3 is an example of a presentation screen displayed by the reservation assistance device;

FIG. 4 is a diagram explaining an example of a data structure and data of status data;

FIG. 5 is an example of a setting screen in which information included in setting data is set;

FIG. 6 is a diagram explaining an example of a data structure and data of reservation data;

FIG. 7 is a diagram explaining an example of a data structure and data of staff data;

FIG. 8 is a flowchart explaining processing by the reservation assistance device;

FIG. 9 is a flowchart explaining proposal processing by a proposal unit according to the embodiment of the present invention;

FIG. 10 is a diagram explaining the system configuration of the processing system and the function blocks of the reservation assistance device according to a first modified example;

FIG. 11 is a flowchart explaining the proposal processing by the proposal unit according to the first modified example;

FIG. 12 is a diagram explaining the system configuration of the processing system and the function blocks of the reservation assistance device according to a second modified example;

FIG. 13 is an example of a selection screen displayed by the proposal unit according to the second modified example;

FIG. 14 is a flowchart explaining the proposal processing by the proposal unit according to the second modified example;

FIG. 15 is an example of a screen in which a customer inputs setting relating to allowance of reservation change in a third modified example;

FIGS. 16A and B are examples of a screen in which sub-start candidate times are displayed or hidden in a fourth modified example;

FIG. 17 is a flowchart explaining processing of the reservation assistance device in the fourth modified example (part 1);

FIG. 18 is a flowchart explaining the processing of the reservation assistance device in the fourth modified example (part 2); and

FIG. 19 is a diagram explaining a hardware configuration of a computer used as the reservation assistance device.

### DETAILED DESCRIPTION

An embodiment of the present invention is explained below with reference to the drawings. The same parts in illustration of the drawings are denoted by the same reference numerals, and explanation thereof is omitted.

A reservation in the embodiment of the present invention is an appointment of providing a service from a reservation start time to a reservation end time that is agreed between a customer and a staff. The reservation secures resources such as a place, a staff, and the like for the customer in a shop such as a beauty salon, a nail salon, a massage salon, a dental clinic, a restaurant, a karaoke box, or a bowling alley. Although the place where the reservation is provided is referred to as shop in the embodiment of the present invention, the place is not limited to the shop. A reservation assistance device 1 is not limited to use in the shop, and may be used in businesses in general in which reservations are accepted such as visiting-type businesses that provide repair services by visiting a place of the customer and on-line type businesses such as language lessons and call taker using the Internet.

In the embodiment of the present invention, the reservation start time and the reservation end time are a start time and an end time of the reservation agreed between the customer and the staff. A reservation time period is a duration of a time period from the reservation start time to the reservation end time, and the customer receives services from the staff within the reservation time period. The reservation start time, the reservation end time, and the reservation time period sometimes vary from a requested start time, a requested end time, and a requested time period inputted by the customer at a moment of reservation, due to a proposal by the reservation assistance device 1 and acceptance of the proposal by the customer. A unit time period is a minimum unit of identification of times such as the reservation start time, the reservation end time, the reservation time period, the requested start time, the requested end time, and the requested time period in the reservation assistance device 1.

In the embodiment of the present invention, when a difference time period between a first time period in which the reservation is unacceptable and a second time period in which the reservation is unacceptable and that is immediately after the first time period is equal to or more than the unit time period and is less than a predetermined time period for a predetermined reservation target such as a staff or a room, this difference time period is referred to as an in-between time period. The unit time period is a minimum time period of the in-between time period. The predetermined time period may be a minimum time period of the reservation time period, or may be a time period set in advance by the staff or the like. The minimum time period of the reservation time period may be a minimum time period secured in the reservation, and may be determined from, for example, a shortest time period in a menu provided by the shop. In the embodiment of the present invention, explanation is given of the case where the unit time period is 15 minutes and the predetermined time period (minimum time period of the reservation time period) is one hour.

### Processing System

A processing system 5 enables accepting of many reservations by proposing a change of the requested start time or the requested end time of the reservation to the customer at the moment of reservation and eliminating the in-between time period. The processing system 5 includes the reservation assistance device 1, a customer terminal 2, and a staff terminal 3. The reservation assistance device 1 can communicate with each of the customer terminal 2 and the staff terminal 3.

General computers execute programs that perform predetermined processing to implement the reservation assistance device 1, the customer terminal 2, the staff terminal 3. The customer who is the subject of the reservation uses the customer terminal 2. The staff who provides the service requested by the reservation uses the staff terminal 3. The reservation assistance device 1 checks requested reservation data 11 inputted by the customer terminal 2, and proposes a change of the reservation to the customer terminal 2 such that no in-between time period occurs.

The reservation is identified based on, for example, the reservation start time, the reservation end time, and the reservation time period from the reservation start time to the reservation end time agreed with the customer. Each staff generally accepts multiple reservations in one day. When the in-between time period occurs between reservations, the number of reservations that the staff can accept in one day is sometimes is reduced from that in the case where no in-between time period occurs. Accordingly, the reservation assistance device 1 proposes a change of the reservation to the customer in acceptance of the reservation to reduce the in-between time period and assist streamlining of businesses.

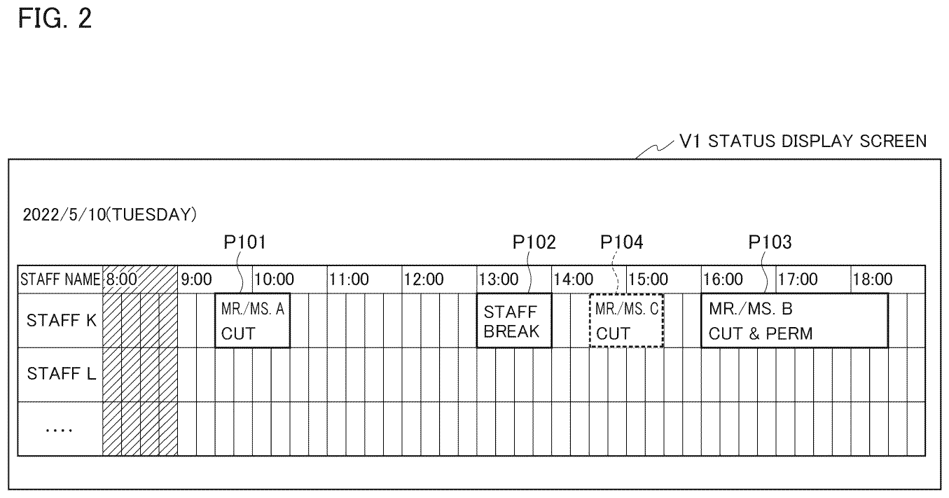

The in-between time period is explained with reference to FIG. 2. FIG. 2 is a status display screen V1 that displays a reservation status of a staff K in a beauty parlor and a work status of the staff K in a timeline. The unit time period in the example illustrated in FIG. 2 is 15 minutes, and the reservation start time, the reservation end time, and the reservation time period are designated in units of 15 minutes. In FIG. 2, the staff K plans to accept a reservation P101 from 9:30 to 10:30 and a reservation P103 from 16:00 to 18:30 and take a break P102 from 13:00 to 14:00. In the example of FIG. 2, reservation unacceptable time periods are identified based on the reservations P101 and P103 and the break P102.

Assume a case where a reservation P104 of one hour from 14:30 is newly made at a request of the customer in such a situation. Assuming that the reservation P104 is accepted as requested by the customer, a period from 14:00 to 14:30 and a period from 15:30 to 16:00 are each 30 minutes. When there is no practice menu that can be provided in 30 minutes, the period from 14:00 to 14:30 and the period from 15:30 to 16:00 become the in-between time periods in which no new reservation is unacceptable.

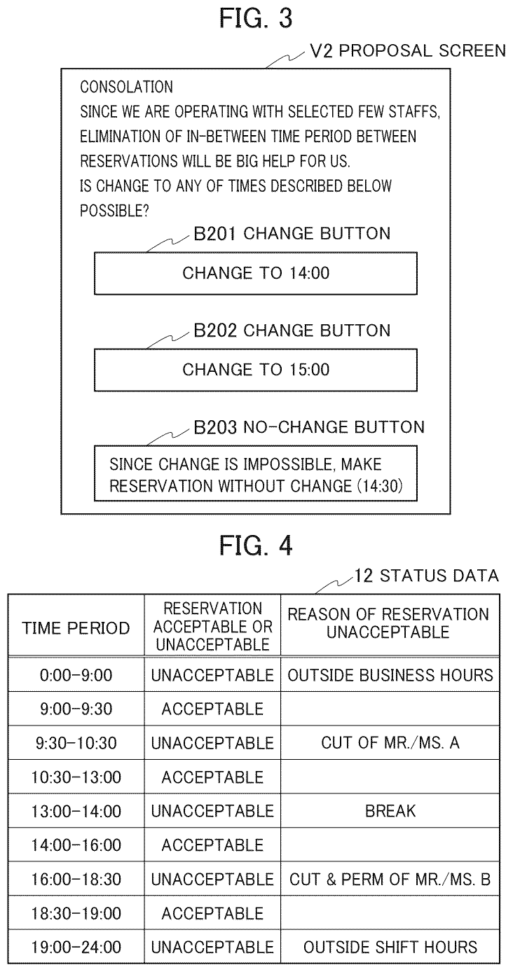

Accordingly, the reservation assistance device 1 displays a proposal screen V2 illustrated in FIG. 3 for the customer terminal 2 of the customer who is attempting to newly make the reservation of one hour from 14:30. The proposal screen V2 is a screen that proposes a change of reservation, and includes a change button B201 that changes the reservation start time from 14:30 to 14:00, a change button B202 that changes the reservation start time from 14:30 to 15:00, and a no-change button B203 that leaves the reservation start time at 14:30. The customer selects the change button B201, the change button B202, or the no-change button B203 according to the convenience of the customer himself/herself on the screen illustrated in FIG. 3.

When the customer accepts the change of the reservation start time to 14:00 and selects the change button B201 in the customer terminal 2, the reservation assistance device 1 changes the reservation start time from 14:30 to 14:00. In this case, a period from 15:00 to 16:00 is a free time period with no reservation, and a free time period in which a new reservation of one hour is acceptable is created. Similarly, when the customer accepts the change of the reservation start time to 15:00 and selects the change button B202 in the customer terminal 2, the reservation assistance device 1 sets the reservation start time from 14:30 to 15:00. In this case, a period from 14:00 to 15:00 becomes a free time period with no reservation, and a free time period in which a new reservation of one hour is acceptable is created.

The reservation assistance device 1 can assist a profit increase by eliminating the in-between time period and creating a continuous free time period in which a new reservation is acceptable or by proposing an additional practice. Moreover, the reservation assistance device 1 proposes a discount such as a coupon to the customer with the change in reservation as described above. This makes it more likely for the customer to accept the proposal, and provides benefits to both of the customer and the shop.

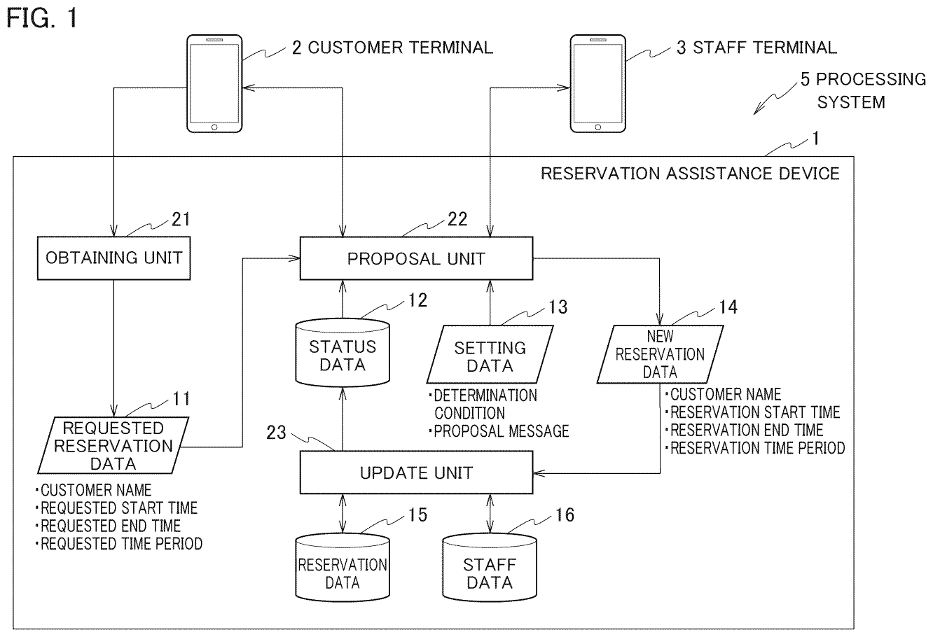

As illustrated in FIG. 1, the reservation assistance device 1 includes pieces of data of the requested reservation data 11, status data 12, setting data 13, new reservation data 14, reservation data 15, and staff data 16 and functions of an obtaining unit 21, a proposal unit 22, and an update unit 23. The pieces of data are stored in a storage device such as a memory 902 or a storage 903. The functions are implemented by a CPU 901. The data structure of each piece of data and the flowchart explaining the processing of each function according to the embodiment of the present invention are examples, and the data structure and the flowchart are not limited to these.

The requested reservation data 11 is data for identifying the reservation inputted from the customer terminal 2 and requested by the customer. The requested reservation data 11 includes a customer name and the requested start time, the requested end time, and the requested time period of the reservation.

The status data 12 is data indicating whether or not the reservation from the customer is acceptable for each of the unit time periods. As illustrated in FIG. 4, in the status data 12, information on acceptation or non-acceptation of reservation such as outside the business hours, the reservation agreed with the customer, and the break of the staff is set for each group of unit time periods in which acceptation or non-acceptation of reservation continues.

For example, the status data 12 is generated by identifying the acceptation or non-acceptation of the reservation for each unit time period based on the reservation data 15 for identifying the reservation agreed with each customer, the staff data 16 for identifying the schedule of each staff such as working hours (shift) of the staff, break hours of the staff, and the like. The status data 12 may be generated by identifying the acceptation or non-acceptation of the reservation for each unit time period based on usage statuses of resources secured in providing of a service such as a room, a seat, a table, and a tool, the number of customers for which the staff can simultaneously perform practice, and the like. Although the status data 12 illustrated in FIG. 4 is data relating to the staff K, the status data 12 can be generated for each staff as well as for each reservation target of the customer such as each table and each room.

Although the case where the reservation assistance device 1 generates the status data 12 in advance is explained in the embodiment of the present invention, the present invention is not limited to this. The status data 12 may be data in which the acceptation or non-acceptation of the new reservation for each unit time period is dynamically identified based on the reservation data 15, the staff data 16, and the like at a timing at which the reservation assistance device 1 refers to the status data 12.

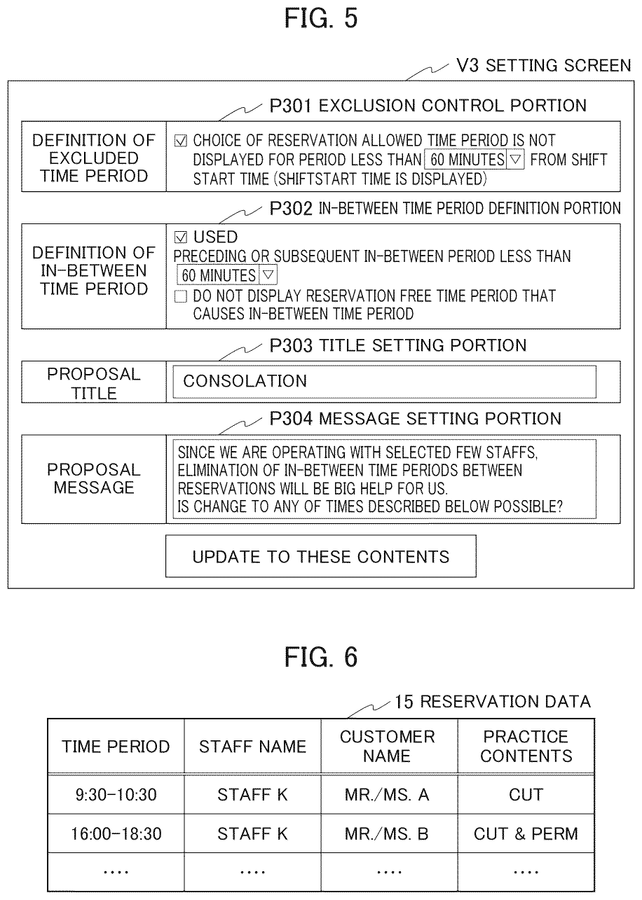

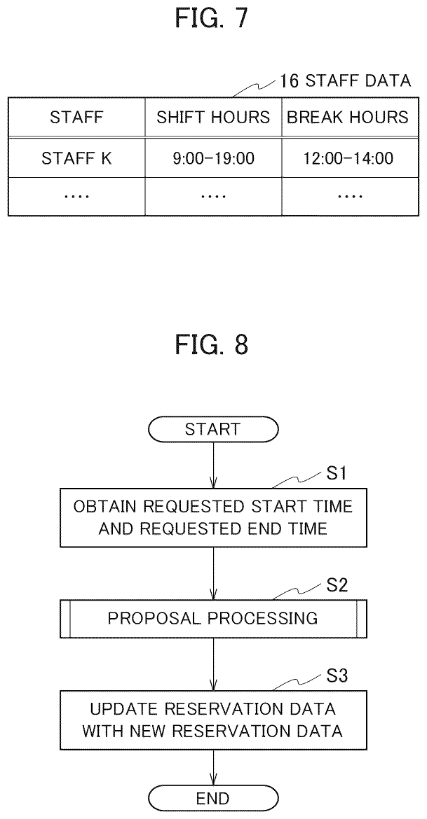

The setting data 13 includes a determination condition to which the reservation assistance device 1 refers to determine the in-between time period, a proposal message to which the reservation assistance device 1 refers when proposing the change of the reservation time period to the customer terminal 2, and the like. The setting data 13 may be set by default, or generated according to information set by a person in charge of the shop or the like, in a setting screen V3 illustrated in FIG. 5.

The setting screen V3 includes an exclusion control portion P301, an in-between time period definition portion P302, a title setting portion P303, and a message setting portion P304. The reservation assistance device 1 refers to conditions whose check boxes are checked in the exclusion control portion P301 and the in-between time period definition portion P302 in determination of the in-between time period, as effective conditions.

A time zone to be excluded as a target of the determination of the in-between time period is set in the exclusion control portion P301. In the exclusion control portion P301 of FIG. 5, a time period less than 60 minutes from a shift start time is set not to be determined as the in-between time period.

An upper limit of a time period to be the in-between time period is set in the in-between time period definition portion P302. Explanation is given of the case where a time period in which there is no reservation and that is the unit time period or more and 60 minutes of less is set as the in-between time period in the in-between time period definition portion P302 of FIG. 5. In the in-between time period definition portion P302 of FIG. 5, a check box “do not display a reservation free time period that causes the in-between time period” is provided. When this check box is checked, only the times for which the in-between time period does not occur are displayed as candidates of the reservation start time presented to the customers as described in a second modified example to be described later.

Templates of proposal messages proposing the change of the reservation time period from the reservation assistance device 1 to the customer terminal 2 are set in the title setting portion P303 and the message setting portion P304. Information set in the title setting portion P303 and the message setting portion P304 is displayed in the proposal screen V2 as illustrated in FIG. 3.

Although explanation is given of the case where the setting data 13 is generated based on information inputted in the setting screen V3, the present invention is not limited to this. For example, the upper limit of the in-between time period that can be set in the in-between time period definition portion P302 may be set to a providing time period of a service that is provided at the minimum time period in the shop or may be set by default. Each piece of information in the title setting portion P303 and the message setting portion P304 may be set by default. Moreover, settings other than those illustrated in FIG. 5 may be set in the setting data 13.

The new reservation data 14 is data for identifying the reservation agreed with the customer. The new reservation data 14 in the embodiment of the present invention is generated by the proposal unit 22. The new reservation data 14 includes the customer name, the reservation start time, the reservation end time, and the reservation time period.

The reservation data 15 is data for identifying the start time and the end time of the reservation accepted from the customer. As illustrated in FIG. 6, the reservation data 15 holds the time period of the reservation, the name of the staff responsible for the reservation, the name of the reserved customer, and the reserved practice contents in association with one another. The reservation data 15 may also be used to identify a method of contacting the customer such as a mail address of the customer.

The staff data 16 is data for identifying the shift hours and the break hours of each staff. The staff data 16 may also be used to identify a method of contacting a staff such as a mail address of the staff.

The obtaining unit 21 obtains the requested start time, the requested end time, and the requested time period of the reservation requested by the customer. When the obtaining unit 21 obtains the requested start time and the requested practice contents of the reservation from the customer, the obtaining unit 21 may identify the requested time period based on the practice contents, and identify the requested end time based on the requested start time and the requested time period. The obtaining unit 21 outputs the requested reservation data 11 including the requested start time, the requested end time, and the requested time period.

The proposal unit 22 refers to the status data 12, and checks whether the reservation is acceptable in the period between the requested start time and the requested end time. When the period between the requested start time and the requested end time includes the reservation unacceptable time period in the status data 12, the proposal unit 22 sends back a reply indicating that the reservation is unacceptable. When the reservation is acceptable in the period between the requested start time and the requested end time and the in-between time period occurs, the proposal unit 22 outputs a proposal for eliminating the in-between time period. In this case, if the time zone to be excluded as the target of the determination of the in-between time period is set in the exclusion control portion P301 or the like of FIG. 5, the proposal unit 22 determines presence or absence of the in-between time period in a time zone to be a target of the determination of the in-between time period.

First, the case where the in-between time period is present before the requested start time is explained. When the in-between time period occurs before the requested start time, the proposal unit 22 proposes advancing of the requested start time.

When the difference time period between the requested start time and the end time of the reservation unacceptable time period immediately before the requested start time is equal to or more than the unit time period and is less than the predetermined time period, the proposal unit 22 determines that the in-between time period is present before the requested start time. In this case, the proposal unit 22 outputs a proposal of changing the requested start time to the end time of the reservation unacceptable time period immediately before the requested start time, to the customer.

Explanation is given with reference to FIG. 2. Explanation is given of the case where the reservation P101, the reservation P103, and the staff break P102 are set as the reservation unacceptable time periods in the status data 12 and the customer requests the new reservation P104. The requested start time of the new reservation P104 is 14:30, the requested end time is 15:30, and the requested time period is one hour. Moreover, the unit time period is 15 minutes. The minimum time period (predetermined time period) of the free time period that is a time period with no reservation and in which the reservation is acceptable is one hour, and the in-between time period is less than one hour (predetermined time period).

In the example illustrated in FIG. 2, the proposal unit 22 determines that a period from 14:00 that is the end time of the reservation unacceptable time period immediately before the requested start time to 14:30 that is the requested start time, as the in-between time period. The proposal unit 22 displays a proposal screen that proposes a change of the requested start time from 14:30 to 14:00, on the customer terminal 2. When an instruction of accepting the proposal is inputted from the customer terminal 2, the proposal unit 22 generates the new reservation data 14 in which the reservation start time is set to 14:00 forwarded from the requested start time. The in-between time period before the requested start time can be thereby eliminated.

In this case, the proposal unit 22 sets the reservation end time of the new reservation data 14 to a time at which the requested time period has elapsed from the reservation start time. Specifically, the proposal unit 22 sets the reservation end time to 15:00 that is a time at which the requested time period of one hour has elapsed from the reservation start time 14:00.

Alternatively, the proposal unit 22 may propose extension of the requested time period to the customer terminal 2 without changing the requested end time. When the instruction of accepting the proposal is inputted from the customer terminal 2, the proposal unit 22 may set the reservation end time of the new reservation data 14 to the requested end time, and set the requested time period to a time period obtained by adding a difference time period (forwarding time period) between the requested start time and the reservation start time to the requested time period. For example, when the requested time is determined depending on practice contents of a beauty parlor or the like in the reservation, the proposal unit 22 proposes an additional practice such as a treatment as the extension of the requested time period, without changing the requested end time. When the instruction of accepting the proposal is inputted from the customer terminal 2, the proposal unit 22 sets the reservation end time in the new reservation data 14 to the requested end time, sets the requested time period to an hour and a half obtained by adding the forwarding time period of 30 minutes to the requested time period of one hour, and generates the new reservation data 14. The reservation assistance device I can thereby eliminate the in-between time period before the requested start time, and also receive the reservation of additional practice.

Next, explanation is given of the case where the in-between time period is present after the requested end time. When the in-between time period occurs after the requested end time, the proposal unit 22 proposes postponing of the requested end time.

When the difference time period between the requested end time and the start time of the reservation unacceptable time period immediately after the requested end time is equal to or more than the unit time period and is less than the predetermined time period, the proposal unit 22 determines that the in-between time period is present after the requested end time. In this case, the proposal unit 22 outputs a proposal of changing the requested end time to the start time of the reservation unacceptable time period immediately after the requested end time.

In the example illustrated in FIG. 2, the proposal unit 22 determines a period from 15:30 that is the requested end time to 16:00 that is the start time of the reservation unacceptable time period immediately after the requested end time as the in-between time period. The proposal unit 22 displays a proposal screen that proposes a change of the requested end time from 15:30 to 16:00 on the customer terminal 2. When the instruction of accepting the proposal is inputted from the customer terminal 2, the proposal unit 22 generates the new reservation data 14 in which the reservation end time is set to 16:00 that is postponed from the requested end time. The in-between time period after the requested end time can be thereby eliminated.

In this case, the proposal unit 22 sets the reservation start time of the new reservation data 14 to a time the requested time period before the reservation end time. Specifically, the proposal unit 22 sets the reservation start time to 15:00 that is the requested time period of one hour before the reservation end time 16:00.

Alternatively, the proposal unit 22 may propose extension of the requested time period to the customer terminal 2 without changing the requested start time. When the instruction of accepting the proposal is inputted from the customer terminal 2, the proposal unit 22 may set the reservation start time of the new reservation data 14 to the requested start time, and set the requested time period to a time period obtained by adding a difference time period (postponing time period) between the requested end time and the reservation end time to the requested time period. For example, when the requested time is determined depending on practice contents of a beauty parlor or the like in the reservation, the proposal unit 22 proposes an additional practice such as a treatment as the extension of the requested time period, without changing the requested start time. When the instruction of accepting the proposal is inputted from the customer terminal 2, the proposal unit 22 sets the reservation start time in the new reservation data 14 to the requested end time, sets the requested time period to an hour and a half obtained by adding the postponing time period of 30 minutes to the requested time period of one hour, and generates the new reservation data 14. The reservation assistance device I can thereby eliminate the in-between time period after the requested start time, and also receive the reservation of additional practice.

When the proposal unit 22 determines that the in-between time periods are present in both of a period before the requested start time and a period after the requested end time in the requested reservation data 11, the proposal unit 22 may present the proposal of advancing the requested start time and the proposal of postponing the requested end time to the customer as in FIG. 3. Moreover, the proposal unit 22 may present the proposal of extending the requested time period to the customer in addition to the proposals illustrated in FIG. 3.

Although explanation is given of the case where the proposal unit 22 displays the proposal screen V2 in which the start time of the reservation is selected such that the in-between time period is eliminated, the proposal unit 22 may display choices of the start time of the reservation that can reduce the in-between time period. For example, in the example illustrated in FIG. 3, a choice of changing the start time to 14:15 that is shifted by the unit time period within a time period in which the in-between time period occurs and a choice of changing the start to 14:45 may be displayed. The in-between time period cannot be eliminated but can be reduced, and a new reservation can be received in some cases.

When the proposal unit 22 generates the new reservation data 14 according to the reply of the customer, the proposal unit 22 inputs the generated new reservation data 14 into the update unit 23. The update unit 23 updates the reservation data 15 and the status data 12 according to the new reservation data 14.

### Reservation Assistance Method

A reservation assistance method according to the embodiment of the present invention is explained with reference to FIG. 8.

In step S1, the reservation assistance device 1 obtains the requested reservation data 11 for identifying the reservation contents requested by the customer. The requested reservation data 11 is used to identify the requested start time and the requested end time of the reservation as well as the requested time period that is the difference between the requested start time and the requested end time.

In step S2, the reservation assistance device 1 performs proposal processing by the proposal unit 22 for the requested reservation data 11 obtained in step S1, and obtains the new reservation data 14.

In step S3, the reservation assistance device 1 updates the reservation data 15 according to the new reservation data 14 obtained in step S2, and also updates the status data 12.

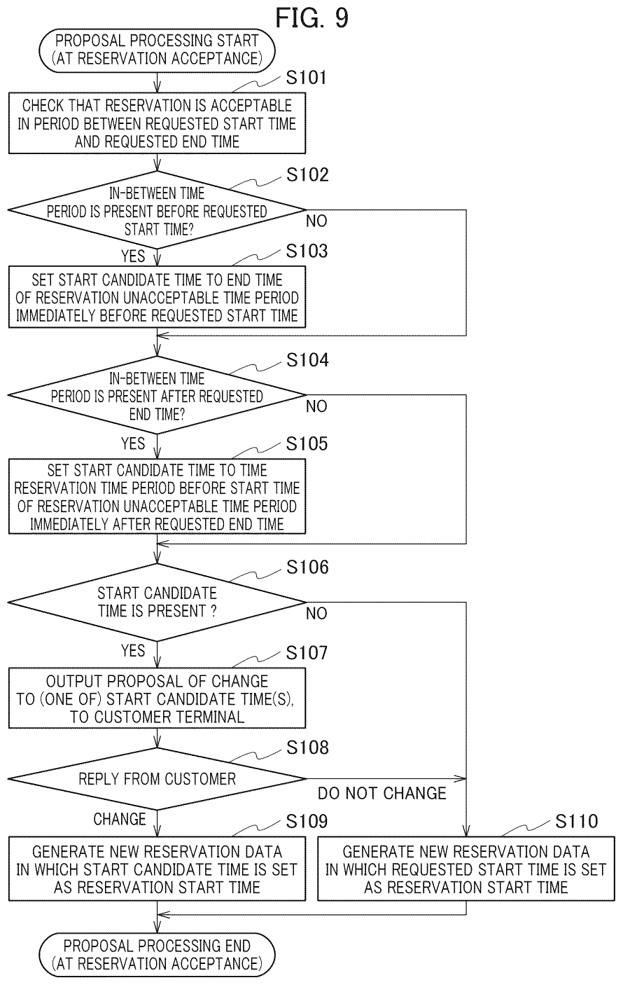

The proposal processing of step S2 is explained with reference to FIG. 9.

In step S101, the reservation assistance device 1 refers to the status data 12, and checks that the reservation is acceptable in the period between the requested start time and requested end time. When the period between the requested start time and the requested end time includes the reservation unacceptable time period, the reservation assistance device 1 sends a request of changing the reservation contents to the customer terminal 2.

In step S102, the reservation assistance device 1 determines whether or not the in-between time period is present before the requested start time. When the in-between time period is absent, the processing proceeds to step S104. When the in-between time period is present, in step S103, the reservation assistance device 1 sets the end time of the reservation unacceptable time period immediately before the requested start time, as the start candidate time, and proceeds to step S104. In the example illustrated in FIG. 2, the reservation assistance device 1 sets the end time 14:00 of the reservation unacceptable time period immediately before the requested start time 14:30, as the start candidate time.

In step S104, the reservation assistance device 1 determines whether or not the in-between time period is present after the requested end time. When the in-between time period is absent, the processing proceeds to step S106. When the in-between time period is present, in step S105, the reservation assistance device 1 sets a time the requested time period before the start time of the reservation unacceptable time period immediately after the requested end time, as the start candidate time, and proceeds to step S106. In the example illustrated in FIG. 2, the reservation assistance device 1 sets the time 15:00 the requested time period of one hour before the start time 16:00 of the reservation unacceptable time period immediately after the requested end time 15:30, as the start candidate time.

In step S106, the reservation assistance device 1 determines whether or not the start candidate time is set in step S103 or step S105. When the start candidate time is not set, the processing proceeds to step S110. When the start candidate time is set, in step S107, the reservation assistance device 1 outputs the proposal of the change to the start candidate time, to the customer terminal 2. When multiple times are set as the start candidate time, the reservation assistance device 1 sends each of the multiple times set as the start candidate time to the customer terminal 2.

When the reservation assistance device 1 receives a reply of changing the requested start time from the customer terminal 2 in step S108, the processing proceeds to S109. When the reservation assistance device 1 receives a reply of not changing the requested start time, the processing proceeds to step S110.

In step S109, the reservation assistance device 1 generates the new reservation data 14 in which the start candidate time is set as the requested start time. When there are multiple start candidate times, the reservation assistance device 1 sets the start candidate time selected in the customer terminal, as the reservation start time.

In step S110, the reservation assistance device 1 generates the new reservation data 14 in which the requested start time is set as the requested start time.

When the new reservation data 14 is generated in step S109 or step S110, the reservation assistance device 1 terminates the processing.

When the in-between time period is present before the requested start time requested by the customer or after the requested end time requested by the customer, the reservation assistance device 1 according to the embodiment of the present invention proposes a change of the reservation start time or the reservation end time to the customer to eliminate the in-between time period. When the instruction of accepting the proposal is inputted from the customer terminal 2, the reservation assistance device 1 generates the new reservation data 14 in which the reservation start time is set such that the in-between time period is eliminated, and accepts the reservation. This can eliminate the in-between time period, and allows accepting of more reservations.

### First Modified Example

Explanation is given of the case where the reservation assistance device 1 according to the embodiment of the present invention proposes the change of the reservation such that the in-between time period is eliminated, at the moment of accepting of reservation from the customer. Meanwhile, a reservation assistance device 1a according to a first modified example searches for the presence or absence of the in-between time period at an arbitrary timing after the accepting of reservation, and when the in-between time period is present, proposes a change of reservations before and after the in-between time period. The reservation assistance device 1a according to the first modified example may be combined with the reservation assistance device 1 according to the embodiment of the present invention to eliminate the in-between time period at the moment of reservation and at an arbitrary timing, or may not be combined with the reservation assistance device 1 according to the embodiment of the present invention to eliminate the in-between time period only at an arbitrary timing.

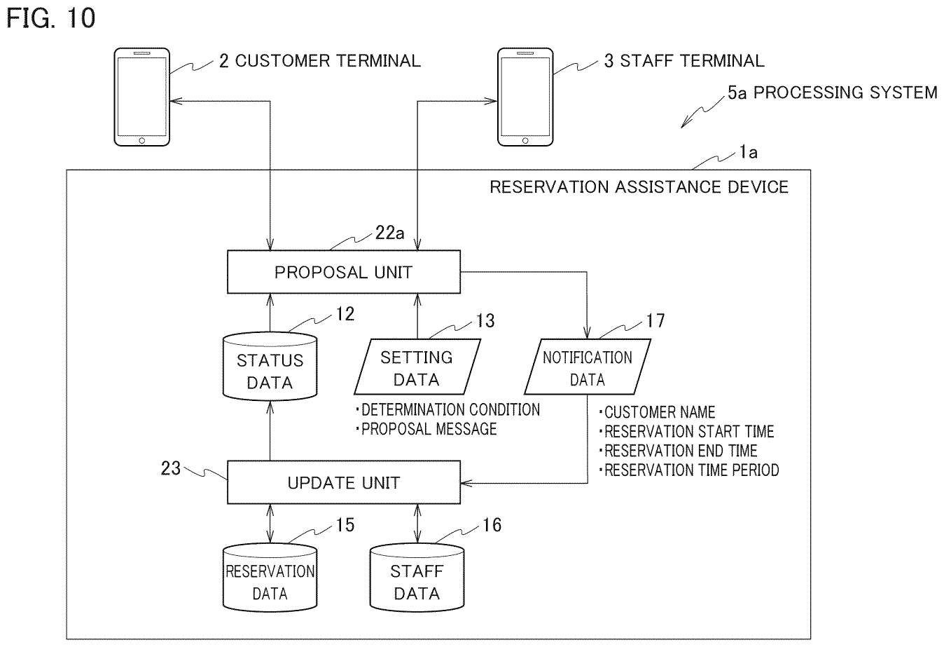

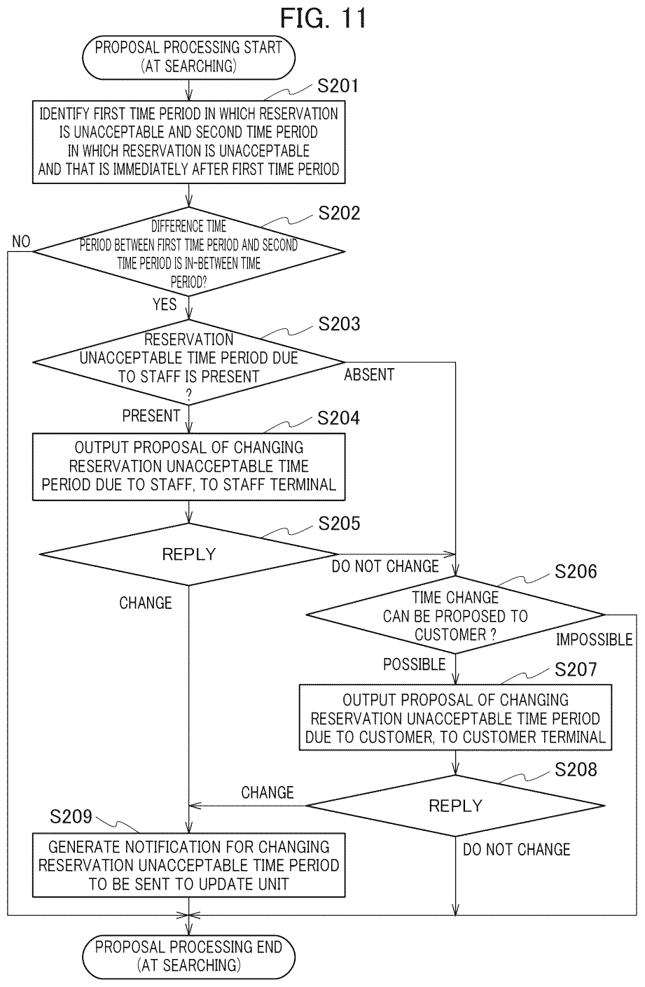

The reservation assistance device 1a according to the first modified example is explained with reference to FIG. 10. The reservation assistance device 1a illustrated in FIG. 10 is different from the reservation assistance device 1 illustrated in FIG. 1 in that the reservation assistance device 1a includes no obtaining unit 21 and includes notification data 17 instead of the new reservation data 14.

When a proposal unit 22a refers to the status data 12 and the difference time period between the first time period in which the reservation is unacceptable and the second time period in which the reservation is unacceptable and that is immediately after the first time period is equal to or more than the unit time period and is less than the predetermined time period, the proposal unit 22a proposes a change of the first time period or the second time period.

For example, assume that the reservation P104 is fixed in the status display screen V1 illustrated in FIG. 2. In this case, the break P102 of the staff is the first time period, and the reservation P104 is the second time period. The proposal unit 22a determines whether or not the difference time period between the first time period and the second time period is equal to or more than the unit time period and is less than the predetermined time period. In the example illustrated in FIG. 2, the difference time period is 30 minutes that is a difference between 14:00 being the end time of the first time period and 14:30 being the start time of the second time period. The difference time period of 30 minutes is equal to or more than the unit time period of 15 minutes, and is less than the predetermined time period of one hour. Accordingly, the proposal unit 22a determines that the in-between time period is present between the break P102 that is the first time period and the reservation P104 that is the second time period, and proposes the change of the first time period or the second time period to terminals of persons who have the right to change the respective time periods.

When the first time period is the change target and the reservation is unacceptable in the first time period due to the reservation of the customer, the proposal unit 22a outputs a proposal of changing the reservation end time to the start time of the second time period, to the customer terminal 2 of the customer who made the reservation for the first time period. When an instruction of accepting the proposal is inputted from the customer terminal 2, the proposal unit 22a generates the notification data 17 for changing the reservation end time of the first time period to the start time of the second time period, and inputs the notification data 17 into the update unit 23.

When the first time period is the change target and the reservation is unacceptable for the first time period due to the break of the staff, the proposal unit 22a outputs a proposal of changing the end time of the break to the start time of the second time period, to the staff terminal 3 of this staff. When an instruction of accepting the proposal is inputted from the staff terminal 3, the proposal unit 22a generates the notification data 17 for changing the break end time of the first time period to the start time of the second time period, and inputs the notification data 17 into the update unit 23. Although the case where the proposal is outputted to the staff terminal 3 is explained herein, the proposal may be outputted to an output device viewable by the staff such as an output device 906 of the reservation assistance device 1a.

Although explanation is given of the case where the first time period is postponed such that no in-between time period occurs between the first time period and the second time period, the present invention is not limited to this. For example, when the in-between time period is present between the first time period and the reservation unacceptable time period immediately before the first time period, the proposal unit 22a may propose a change of the start time of the first time period to the end time of the reservation unacceptable time period immediately before the first time period. When the instruction of accepting the proposal is inputted from the customer terminal 2 or the staff terminal 3, the proposal unit 22a generates the notification data 17 for changing the start time of the first time period to the end time of the reservation unacceptable time period immediately before the first time period, and inputs the notification data 17 into the update unit 23.

When the second time period is the change target and the reservation is unacceptable for the second time period due to the reservation of the customer, the proposal unit 22a outputs a proposal of changing the reservation start time to the end time of the first time period, to the customer terminal 2 of the customer who made the reservation for the second time period. When an instruction of accepting the proposal is inputted from the customer terminal 2, the proposal unit 22a generates the notification data 17 for changing the reservation start time of the second time period to the end time of the first time period, and inputs the notification data 17 into the update unit 23.

When the second time period is the change target and the reservation is unacceptable for the second time period due to the break of the staff, the proposal unit 22a outputs a proposal of changing the start time of the break to the end time of the first time period, to the staff terminal 3 of this staff. When an instruction of accepting the proposal is inputted from the staff terminal 3, the proposal unit 22a generates the notification data 17 for changing the break start time of the second time period to the end time of the first time period, and inputs the notification data 17 into the update unit 23.

Although explanation is given of the case where the second time period is advanced such that no in-between time period occurs between the first time period and the second time period, the present invention is not limited to this. For example, when the in-between time period is present between the second time period and the reservation unacceptable time period immediately after the second time period, the proposal unit 22a may propose a change of the end time of the second time period to the start time of the reservation unacceptable time period immediately after the second time period. When the instruction of accepting the proposal is inputted from the customer terminal 2 or the staff terminal 3, the proposal unit 22a generates the notification data 17 for changing the end time of the second time period to the start time of the reservation unacceptable time period immediately after the second time period, and inputs the notification data 17 into the update unit 23. The update unit 23 updates the reservation data 15, the staff data 16, and the status data 12 according to the notification data 17.

In this case, the proposal unit 22a may propose a change of the reservation or the break in the order determined in advance for the first time period and the second time period.

For example, assume that one of the first time period and the second time period is the break hours of the staff, and the other is the reservation time period of the customer. First, the proposal unit 22a may proposes the change of the break hours of the staff, and when the proposal is not accepted, propose the change of the reservation of the customer.

The proposal unit 22a may determine a proposal destination such that no further proposal is made to a customer to which a proposal has been made in the past or a customer who did not accept the proposal. The proposal unit 22a holds the number of times of proposal, the number of times of unacceptance of proposal, the number of times of acceptance of proposal, and the like for each customer in the reservation data 15 or the status data 12.

For example, when the proposal unit 22a has made the proposal predetermined times or more to a customer who has made the reservation for the first time period, the proposal unit 22a does not make the proposal to the customer of the first time period, and proposes a change of the second time period. Moreover, when the reservations for the first time period and the second time period are made, respectively, by different customers, the proposal unit 22a may preferentially propose the change of the reservation to a customer selected from the different customers based on a predetermined standard such as a customer to which the number of times of proposal made in the past is fewer, a customer who has rejected the proposal fewer times in the past, or a customer who has accepted the proposal more times in the past.

Moreover, when the proposal unit 22a refers to the status data 12 for one day and finds multiple in-between time periods, the proposal unit 22a may identify the reservation unacceptable time period that can efficiently eliminate the in-between time periods, and propose a change to the identified reservation unacceptable time period.

For example, in the example illustrated in FIG. 2, when the reservation P104 is fixed, the in-between time periods are present between the break 102 and the reservation P104 and between the reservation P104 and the reservation P103. In this case, (i) a time change of the break P102 and the reservation P103 or (ii) a time change of the reservation P104 can eliminate two in-between time periods. In (i), postponing the break P102 by 30 minutes and forwarding the reservation P103 by 30 minutes can make the in-between time periods before and after the reservation P104 zero. Alternatively, forwarding the break P102 by 30 minutes and postponing the reservation P103 by 30 minutes can create free time periods of one hour before and after the reservation P104. In (ii), forwarding the reservation P104 by 30 minutes can make the in-between time period before the reservation P104 zero, and create a free time period of one hour after the reservation P104. Alternatively, postponing the reservation P104 by 30 minutes can make the in-between time period after the reservation P104 zero, and create a free time period of one hour before the reservation P104.

In the plan (i), the in-between time periods are not eliminated unless the change is accepted for both of the break P102 and the reservation P103. Meanwhile, in the plan (ii), the in-between time periods are eliminated only with the change of the reservation P104. Accordingly, the proposal unit 22a may propose the reservation change according to (ii) with fewer change proposal destinations.

The proposal processing by the proposal unit 22a according to the first modified example is explained with reference to FIG. 11. In the example of FIG. 11, explanation is given of the case where a change of the reservation unacceptable time period due to the staff is preferentially proposed.

In step S201, the proposal unit 22a refers to the status data 12, and identifies the first time period in which the reservation is unacceptable and the second time period in which the reservation is unacceptable and that is immediately after the first the time period. In step S202, the proposal unit 22a determines whether the difference time period between the first time period and the second time period identified in step S201 is the in-between time period or not. When the difference time period is not the in-between time period, the proposal unit 22a terminates the processing.

When the difference time period is the in-between time period, in step S203, the proposal unit 22a determines whether or not the reservation unacceptable time period due to the staff is present in the first time period and the second time period. When the reservation unacceptable time period due to the staff is absent, the processing proceeds to step S206. When the reservation unacceptable time period due to the staff is present, in step S204, the proposal unit 22a outputs a proposal of changing the reservation unacceptable time period due to the staff, to the staff terminal 3. When an instruction of no change is inputted from the staff terminal 3, the processing proceeds to step S206. When an instruction of change is inputted, the processing proceeds to step S209.

In step S206, the proposal unit 22a outputs a proposal of changing the reservation unacceptable time period to the customer terminal 2 of one of the customers of the first time period and the second time period or each of the customers. When the instruction of change is inputted, the processing proceeds to step S209. When the instruction of no change is inputted from the staff terminal 3, the processing is terminated.

In step S209, the proposal unit 22a generates the notification data 17 for changing the reservation unacceptable time period for which the staff or the customer has accepted the proposal of change. The proposal unit 22a inputs the notification data 17 into the update unit 23, and terminates the processing.

The reservation assistance device 1a according to the first modified example searches for the in-between time period at an arbitrary timing even after the reservation of the customer, and proposes the change of the already-made reservation of the customer or the plan of the staff such that the in-between time period is eliminated. This can eliminate the in-between time period, and allows accepting of more reservations. Moreover, even if the customer does not accept the change of reservation at the moment of the reservation in the embodiment of the present invention, the already-made reservation can be changed. Accordingly, the in-between time period can be eliminated more efficiently.

When the reservation assistance device 1a of the first modified example requests the change of reservation, the reservation assistance device 1a may propose the change of the reservation start time such that no in-between time period occurs before and after the reservation. Alternatively, the reservation assistance device 1a may propose the change of the reservation start time such that the in-between time period does not occur in at least one of periods before and after the reservation or is reduced. The “in-between time period does not occur” means that, when the in-between time period of 30 minutes is present before the reservation start time, the in-between time period is made zero by forwarding the reservation start time by 30 minutes or a free time period of one hour or more is created by postponing the reservation start time by 30 minutes or more. The “in-between time period is reduced” means that, when the in-between time period of 30 minutes is present before the reservation start time, the in-between time period is reduced from 30 minutes to 15 minutes by forwarding the reservation start time by 15 minutes.

### Second Modified Example

In the embodiment and the first modified example of the present invention, explanation is given of the case where the reservation is changed when the in-between time period occurs at the moment of accepting of reservation or after accepting of reservation. Meanwhile, a reservation assistance device 1b according to a second modified example performs control such that no in-between time period occurs by not including time periods that cause the in-between time period in candidates of the start time of reservation when the customer specifies the start time of reservation.

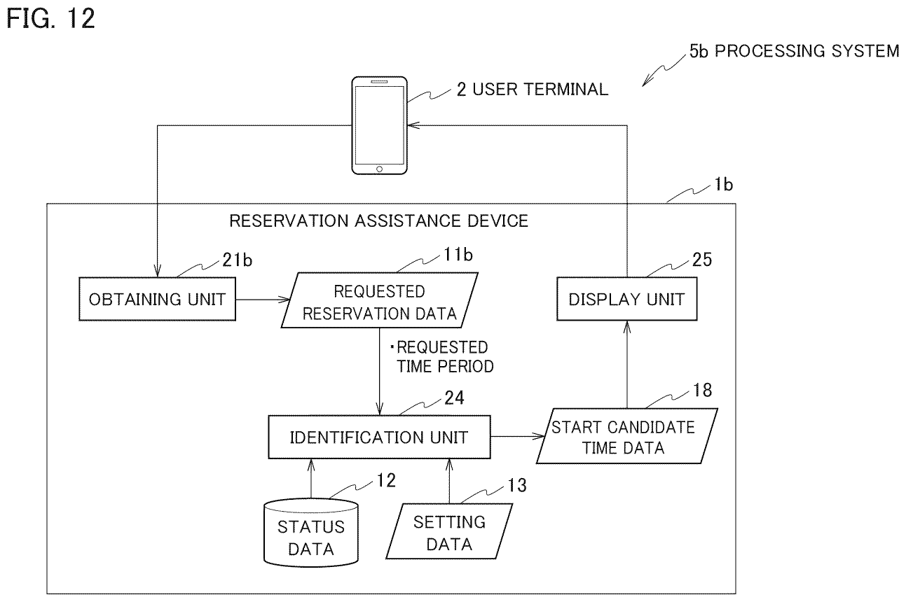

The reservation assistance device 1b according to the second modified example is explained with reference to FIG. 12. The reservation assistance device 1b according to the second modified example is different from the reservation assistance device 1 according to the embodiment of the present invention in the obtaining unit 21 and the contents of the requested reservation data 11, and the reservation assistance device 1b includes start candidate time data 18, an identification unit 24, and a display unit 25 instead of the new reservation data 14 and the proposal unit 22. The status data 12 and the setting data 13 in FIG. 12 are as explained in the embodiment of the present invention and the like. Note that, although omitted in the example illustrated in FIG. 12, the reservation assistance device 1b according to the second modified example may also include the reservation data 15, the staff data 16, and the update unit 23 illustrated in FIG. 1 like the reservation assistance device 1 according to the embodiment of the present invention.

The obtaining unit 21 obtains the requested time period of the reservation requested by the customer. The obtaining unit 21 obtains the requested time period of the reservation itself from the customer terminal 2. Alternatively, the obtaining unit 21 obtains a requested practice menu from the customer terminal 2, and obtains the requested time period of the reservation based on a time period for providing the obtained practice menu. The obtaining unit 21 may obtain a requested date on which the reservation is requested, in addition to the requested time period.

The identification unit 24 identifies the start candidate times of the reservation at which the reservation is acceptable for the requested time period of the reservation and at which no in-between time period occurs in a period before or after the reservation. Specifically, the identification unit 24 identifies the start candidate times of the reservation by excluding the start candidate times of the reservation at which the in-between time period occurs in both of the periods before and after the reservation from the start candidate times of the reservation at which the reservation is acceptable for the requested time period of the reservation. In the case where the obtaining unit 21 also obtains the requested date, the identification unit 24 identifies the start candidate times in the requested date. Although the case where the start candidate times of the reservation at which no in-between time period occurs in at least one of the periods before and after the reservation is at least identified is explained in the second modified example, the start candidate times of the reservation at which no in-between time period occurs in both of the periods before and after the reservation may be identified.

The identification unit 24 refers to the status data 12, and identifies the start candidate time at which the difference time period between the start candidate time and the end time of the reservation unacceptable time period immediately before the start candidate time is zero or equal to or more than the predetermined time period or the start candidate time at which the difference time period between a time at which the requested time period has elapsed from the start candidate time to the start time of the reservation unacceptable time period immediately after this time is zero or equal to or more than the predetermined time period, from the start candidate times at which the reservation of the requested time period is acceptable.

The display unit 25 displays the start candidate times identified by the identification unit 24, on the customer terminal 2. The reservation assistance device 1b receives the start time specified from the start candidate times by the customer from the customer terminal 2, and generates the new reservation data 14 in which: the reservation start time is set to the start time specified by the customer; the reservation end time is set to a time at which the requested time period has elasped from the start time specified by the customer; and the reservation time period is set to the requested time period. The reservation assistance device 1b updates the status data 12 and the reservation data 15 according to the new reservation data 14.

Explanation is given of processing in the case where the identification unit 24 identifies the start candidate times of the reservation by excluding the start candidate times of the reservation at which the in-between time period occurs in both of the periods before and after the reservation in the second modified example. The identification unit 24 identifies the start candidate times of the reservation by allowing the case where no in-between time period occurs in both of the periods before and after the reservation, the case where the in-between time period occurs in the period before the reservation but not in the period after the reservation, and the case where the in-between time period occurs in the period after the reservation but not in the period before the reservation.

Explanation is given of processing of the identification unit 24 in the case where the reservation P101, the break P102, and the reservation P103 are fixed in the example illustrated in FIG. 2 and the customer specifies one hour as the requested time period.

In the example illustrated in FIG. 2, the start candidate times at which the reservation for the time period of one hour requested by the customer is acceptable are 10:30, 10:45, 11:00, 11:15, 11:30, 11:45, 12:00, 14:00, 14:15, 14:30, 14:45, and 15:00.

When the start candidate time is set to 10:30, the difference time period between the start candidate time 10:30 and the end time 10:30 of the reservation unacceptable time period immediately before the start candidate time is zero, and no in-between time period occurs. When the start candidate time is set to 10:45, the difference time period between the start candidate time 10:45 and the end time 10:30 of the reservation unacceptable time period immediately before this time 10:45 is 15 minutes, and the in-between time period thus occurs. Meanwhile, since the difference time period between the time 11:45 at which the requested time period of one hour has elapsed from the start candidate time 10:45 and the start time 13:00 of the reservation unacceptable time period immediately after this time 11:45 is one hour or more, no in-between time period occurs. Similarly, when the start candidate time is set to 11:00, 11:30, 11:45, 12:00, 14:00, or 15:00, no in-between time period occurs in at least one of the period before the start candidate time and the period after the time at which the requested time period of one hour has elapsed from the start candidate time. Accordingly, the start candidate times are 10:30, 10:45, 11:00, 11:30, 11:45, 12:00, 14:00, and 15:00.

Meanwhile, when the start candidate time is set to 11:15, the difference time period between the start candidate time 11:15 and the end time 10:30 of the reservation unacceptable time period immediately before the start candidate time is 45 minutes, and the in-between time period occurs. Moreover, since the difference time period between 12:15 that is one hour after the start candidate time 11:15 and the start time 13:00 of the reservation unacceptable time period immediately after this time 12:15 is 45 minutes, the in-between time period occurs. When the start candidate time is set to 11:15, the in-between time period occurs in both of the period before the start candidate time and the period after the time at which the requested time period of one hour has elapsed from the start candidate time. Similarly, when the start candidate time is set to 14:15, 14:30, or 14:45, the in-between time period occurs in both of the period before the start candidate time and the period after the time at which the requested time period of one hour has elasped from the start candidate time. Accordingly, 11:15, 14:15, 14:30, and 14:45 are excluded from the start candidate times.

Accordingly, in the case of the example illustrated in FIG. 2, the identification unit 24 identifies the start times 10:30, 10:45, 11:00, 11:30, 11:45, 12:00, 14:00, and 15:00 at which no in-between time period occurs in at least one of the period before the start time and the period after the end time, as the start candidate times, from among the start times 10:30, 10:45, 11:00, 11:15, 11:30, 11:45, 12:00, 14:00, 14:15, 14:30, 14:45, and 15:00 at which the reservation for the time period of one hour requested by the customer is acceptable.

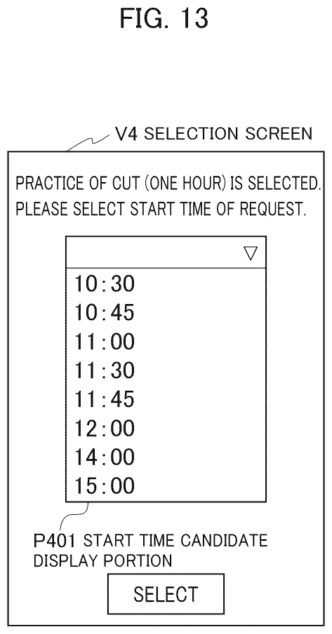

As illustrated in FIG. 13, the display unit 25 displays a selection screen V4 in which one of the start candidate times identified by the identification unit 24 can be selected, on the customer terminal 2, and causes the customer to select one of the start candidate times.

The processing of the identification unit 24 is an example, and the present invention is not limited to this. For example, if the reservation assistance device 1b accepts only the reservation for which no in-between time period occurs in one of the periods before and after the reservation time period in a predetermined condition such as the case where the number of reservation in one day reaches or exceeds a predetermined number or the case where the number of days between the current date and the date of reservation is small, the reservation assistance device 1b may be unable to accept the reservation itself. Accordingly, when the predetermined condition that allows the in-between time period is satisfied, the identification unit 24 may change the identification method of the start candidate times such that more start candidate times are identified. For example, the identification unit 24 may identify not only the start times at which no in-between time period occurs in at least one of the periods before and after the reservation time period, but also the start times at which the in-between time period occurs in both of the periods before and after the reservation time period, as the start candidate times.

Moreover, in a predetermined condition such as the case where the number of days between the current date and the date of the reservation is large, the reservation assistance device 1b may accept only the reservation for which no in-between time period occurs in both of the periods before and after the reservation time period. When the predetermined condition that does not allow the in-between time period is satisfied, the identification unit 24 may identify the start candidate times at which no in-between time period occurs in both of the periods before and after the reservation time period.

Explanation is given of the case where the reservation assistance device 1b accepts only the reservation for which no in-between time period occurs in both of the periods before and after the reservation time period. In this case, the identification unit 24 identifies only the case where no in-between time period occurs in both of periods before and after the reservation, as the start candidate time. The case where the in-between time period occurs in the period before the reservation but not in the period after the reservation and the case where the in-between time period occurs in the period after the reservation but not in the period before the reservation are excluded from the start candidate times.

In the example illustrated in FIG. 2, the start candidate times at which the reservation for the time period of one hour requested by the customer is acceptable are 10:30, 10:45, 11:00, 11:15, 11:30, 11:45, 12:00, 14:00, 14:15, 14:30, 14:45, and 15:00. When 10:45 and 11:00 among these start candidate times are each set as the start candidate time, no in-between time period occurs in the period after the time at which the requested time period of one hour has elapsed the start candidate time, but the in-between time period occurs in the period before the start candidate time. When 11:30 and 11:45 are each set as the start candidate time, no in-between time period occurs in the period before the start candidate time, but the in-between time period occurs in the period after the time at which the requested time period of one hour has elapsed from the start candidate time. When 11:15, 14:15, 14:30, and 14:45 are each set as the start candidate time, the in-between time period occurs in both of the period before the start candidate time and the period after the time at which the requested time period of one hour has elapsed from the start candidate time.

Accordingly, when the reservation assistance device 1b accepts only the reservation for which no in-between time period occurs in both of the periods before and after the reservation time period, the identification unit 24 identifies 10:30, 12:00, 14:00, and 15:00 as the start candidate times.

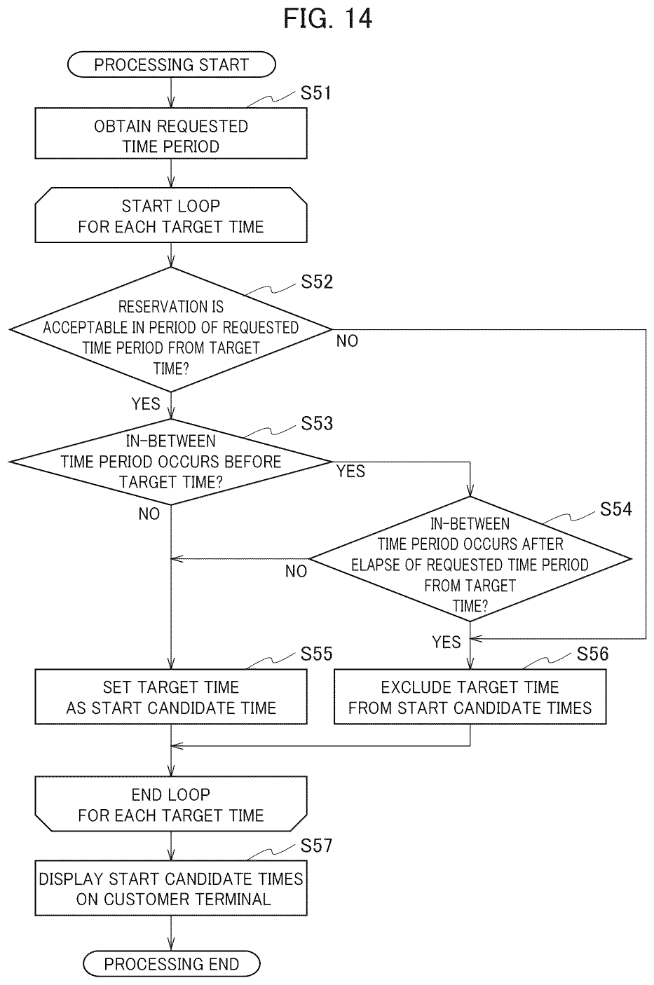

Processing of the reservation assistance device 1b according to the second modified example is explained with reference to FIG. 14. Explanation is given of processing in the case where reservation assistance device 1b identifies the start candidate times of the reservation by excluding the start candidate times of the reservation at which the in-between time period occurs in at least one of the periods before and after the reservation.

In step S51, the reservation assistance device 1b obtains the requested time period and the requested date for which the customer requests to make the reservation.

The reservation assistance device 1b performs processing of step S52 to step S56 for each of target times of the requested date. The target times are set every unit time period.

In step S52, the reservation assistance device 1b refers to the status data 12, and determines whether or not the reservation is acceptable in a period of the requested time period from the target time. When the period includes the reservation unacceptable time period, the processing proceeds to step S56. When the reservation is acceptable, the processing proceeds to step S53.

In step S53, the reservation assistance device 1b determines whether or not the in-between time period occurs before the target time. When no in-between time period occurs, the processing proceeds to step S55. Meanwhile, when the in-between time period occurs before the target time, the processing proceeds to step S54.

In step S54, the reservation assistance device 1b determines whether or not the in-between time period occurs after elapse of the requested time period from the target time. When the in-between time period occurs, the processing proceeds to step S56. When no in-between time period occurs, the processing proceeds to step S55.

In step S55, the reservation assistance device 1b sets the target time as the start candidate time. Meanwhile, in step S56, the reservation assistance device 1b excludes the target time from the start candidate times.

When the processing from step S52 to step S56 is completed for each target time, the processing proceeds to step S57. In step S57, the reservation assistance device 1b displays each of the start candidate times set in step S55 on the customer terminal 2. The reservation assistance device 1b generates the new reservation data 14 with the start candidate time selected in the customer terminal 2 set as the reservation start time.

The reservation assistance device 1b according to the second modified example displays only the start candidate times of the reservation at which no in-between time period occurs in at least one of the periods before and after the reservation, on the customer terminal 2, and causes the customer to select the start time requested by the customer from the start candidate times. The reservation assistance device 1b can thereby assist streamlining of businesses.

After the reservation is made by the second modified example by identifying the start time of the reservation from the start candidate times of the reservation at which no in-between time period occurs in at least one of the periods before and after the reservation, this reservation or the reservation unacceptable time period before or after this reservation may be shifted as explained in the first modified example. The reservation assistance device 1b can thereby eliminate the in-between time period.

### Third Modified Example

In the embodiment of the present invention, there is a case where no in-between time period occurs before the reservation start time or after the reservation end time at the moment of reservation by the customer. However, there is a case where, after this reservation of the customer, the in-between time period occurs afterwards due to accepting of a reservation of another customer. In the third modified example, elimination of the in-between time period is made possible also in the case where the in-between time period occurs afterwards.

Accordingly, in the third modified example, when no in-between time period occurs before the reservation start time and after the reservation end time at the moment of reservation by the customer, the reservation assistance device 1 inquires the customer whether or not the reservation can be changed afterwards. When the customer answers that the reservation change is possible, the reservation assistance device 1 sets this information in the new reservation data 14, and reflects the information in the reservation data 15.

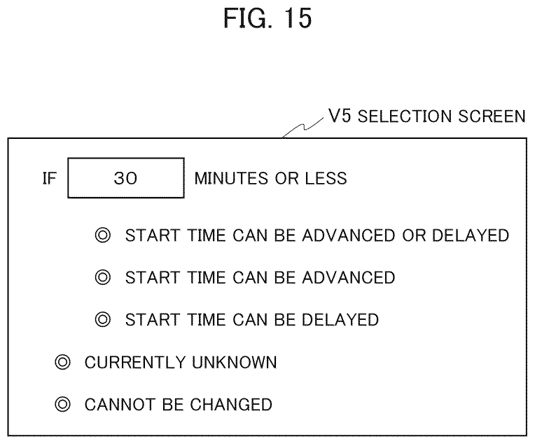

For example, when it is before the execution of step S3 in FIG. 8 and no in-between time period occurs before the reservation start time requested by the customer and after the reservation end time requested by the customer, the reservation assistance device 1 displays a selection screen V5 illustrated in FIG. 15, and inquires the customer whether or not the reservation can be changed afterwards. Alternatively, when it is before the execution of the processing of step S110 in FIG. 9 and the customer does not agree with a change to one of the start time candidates presented by the reservation assistance device 1, the reservation assistance device 1 may display the selection screen V5 illustrated in FIG. 15, and inquire the customer whether or not the reservation can be changed afterwards. In this case, the inquiry of step S107 in FIG. 9 and the inquiry of the selection screen V5 may be implemented on one screen. The selection screen V5 causes the customer to input whether or not advancing or delaying of the start time is possible and, when the change is possible, a time period in which the change is allowable. In step S110, the reservation assistance device 1 sets the answer inputted in the selection screen V5 in the new reservation data 14, and reflects the answer in the reservation data 15.

In the third modified example, the reservation assistance device 1 refers to the status data 12 at a predetermined timing, and when the difference time period between the first time period in which the reservation is unacceptable and the second time period in which the reservation is unacceptable and that is immediately after the first time period is equal to or larger than the unit time period and is less than the predetermined time period, propose a change of the first time period or the second time period. This timing is, for example, a timing at which no change of the reservation occurs such as after an end of a period of accepting a reservation change or cancel. Alternatively, this timing is a timing at which a reservation change is less likely to occur such after business close of a day before the reservation date. As another alternative, this timing is a timing at which occurrence of in-between time period due to accepting of a new reservation is found.

In this case, when the customer who made the reservation for the first time period is the customer who answered that the time change is possible at the moment of reservation, the reservation assistance device 1 outputs a proposal of changing the reservation end time to the start time of the second time period, to this customer. When the customer who made the reservation for the second time period is the customer who answered that the time change is possible at the moment of reservation, the reservation assistance device 1 outputs a proposal of changing the reservation start time to the end time of the first time period, to this customer. This proposal is notified by an e-mail, an SMS (short message service), an application, an SNS (social networking service) or the like. The reply of the customer to the proposal may be sent back by means by which the reservation assistance device 1 has made the proposal, or by a web site to which the customer is guided by a URL described in notification contents. The proposal and the reply can be made by any means as long as the proposal reaches the customer from the reservation assistance device 1 and the reply of the customer to this proposal reaches the reservation assistance device 1.

When the difference time period between the first time period and the second time period is reduced by time change contents allowed by the customer in advance, the reservation assistance device 1 may propose the time change. For example, when the customer is a person who made the reservation for the first time period and who set that the reservation can be postponed by 30 minutes and the difference time period between the first time period and the second time period is 45 minutes, postponing the reservation by the customer can reduce the difference time period from 45 minutes to 15 minutes. The reservation assistance device 1 proposes postponing of the reservation by 30 minutes to the customer. When the difference time period between the first time period and the second time period becomes equal to or more than the predetermined time period by the time change contents allowed by the customer in advance, the reservation assistance device 1 may propose the time change. For example, when the customer is a person who made the reservation for the first time period and who set that the reservation can be forwarded by 30 minutes and the difference time period between the first time period and the second time period is 45 minutes, advancing the reservation by the customer can increase the difference time period from 45 minutes to one hour and 15 minutes, and accepting of a new reservation becomes possible. When the difference time period between the first time period and the second time period becomes zero by the time change contents allowed by the customer in advance, the reservation assistance device 1 may propose the time change.

Note that, although the case where the customer sets whether or not the time change is possible at the moment of reservation is explained in the third modified example, the present invention is not limited to this. When the customer performs default setting or the like and answers in advance that the time change is possible before the finding of occurrence of the in-between time period before or after the reservation at any of the moment of reservation, the moment before the reservation, and the moment after the reservation of the customer, the reservation assistance device 1 proposes the time change to this customer.

When the customer accepts the proposal by the reservation assistance device 1, the in-between time period can be reduced. This allows the staff to deal with a new customer or have solid blocks of time for work. This allows effective use of work time and an increase of sales in the shop.

### Fourth Modified Example

Explanation is given of the case where the reservation assistance device 1 according to a fourth modified example performs control such that, when the customer specifies the start time of the reservation, the time at which the in-between time period occurs is made less likely to be selected as the candidate of the start time, and the in-between time period is thereby made less likely to occur. In comparison to the second modified example, in the fourth modified example, the reservation assistance device 1 allows the customer to select the time at which the in-between time period occurs, but displays the candidates of the start time such that the time at which no in-between time period occurs is more likely to be selected.

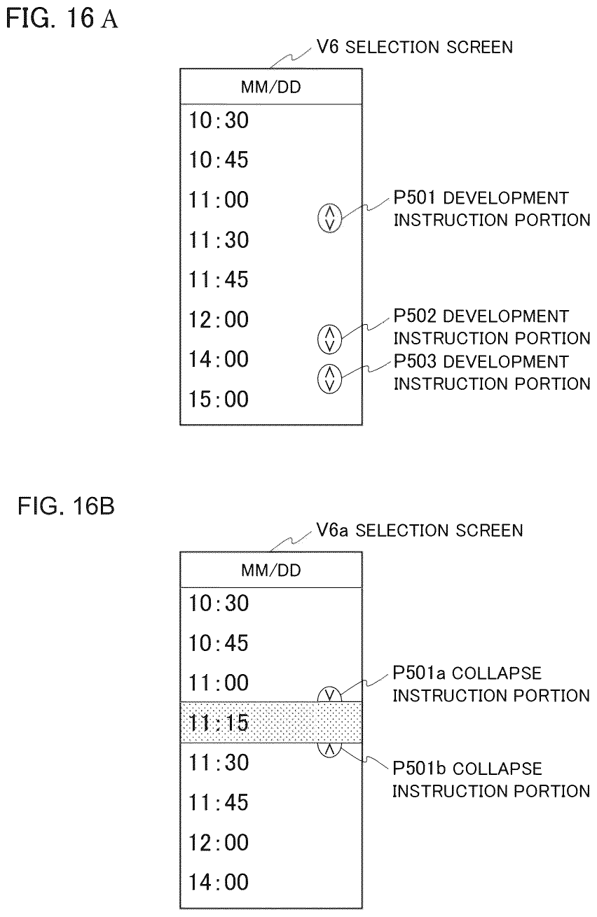

Specifically, the display unit 25 of the reservation assistance device 1 displays a selection screen V6 illustrated in FIG. 16A on the customer terminal 2 to allow selection of the reservation start time. The selection screen V6 displays the start candidate times at which no in-between time period occurs in at least one of the periods before and after the reservation time period, among the start candidate times at which the reservation of the requested time period specified by the customer is acceptable, in a list box. Specifically, each of the start candidate times at which no in-between time period occurs in the periods before and after the reservation time period is such a time that the difference time period between the start candidate time and the end time of the reservation unacceptable time period immediately before the start candidate time is zero or equal to or more than the predetermined time, or the difference time period between the time at which the requested time period has elapsed from the start candidate time and the start time of the reservation unacceptable time period immediately after this time is zero or equal to or more than the predetermined time period.

As illustrated in FIG. 16A, the display unit 25 displays the start candidate times at which no in-between time period occurs in the periods before and after the reservation time period, in the list box of the selection screen V6 for selecting the reservation start time. The start candidate times at which no in-between time period occurs in at least one of the periods before and after the reservation time period are 10:30, 10:45, 11:00, 11:30, 11:45, 12:00, 14:00, and 15:00 as explained in the second modified example.

The identification unit 24 of the reservation assistance device 1 identifies, in addition to the start candidate times at which no in-between time period occurs in at least one of the periods before and after the reservation time period, sub-start candidate times at which the in-between time period occurs in both of periods before and after the reservation time period. The sub-start candidate times are each the start candidate time at which the difference time period between the start candidate time and the end time of the reservation unacceptable time period immediately before the start candidate time is less than the predetermined time period and the difference time period between the time at which the requested time period has elapsed from the start candidate time and the start time of the reservation unacceptable time period immediately after this time is less than the predetermined time period, among the start candidate times at which the reservation of the requested time period specified by the customer is acceptable.

As illustrated in FIG. 16B, the display unit 25 displays the start candidate times at which no in-between time period occurs in the periods before and after the reservation time period in the list box of a selection screen V6a in response to an instruction of the customer, and when a development instruction portion P501 provided between 11:00 and 11:30 is selected in the selection screen V6 of FIG. 16A, displays the sub-start candidate time in the selection screen V6a illustrated in FIG. 16B. In FIG. 16B, 11:15 is displayed as the sub-start candidate time between the start candidate times 11:00 and 11:30. The customer can thereby select not only the start candidate times at which no in-between time period occurs, but also the sub-start candidate times at which the in-between time period occurs.

Specifically, when the sub-start candidate time is present between two adjacent start candidate times among the start candidate times, the display unit 25 displays the development instruction portion corresponding to the two adjacent start candidate times in the list box. When the development instruction portion is selected, the display unit 25 displays the sub-start candidate time between the two adjacent start candidate times in the list box.

In the selection screen V6 of FIG. 16A, the development instruction portion P501 is displayed between the start candidate times 11:00 and 11:30. A development instruction portion P502 is displayed between the start candidate times 12:00 and 14:00. A development instruction portion P503 is displayed between the start candidate times 14:00 and 15:00.

When the customer clicks the development instruction portion P501 in this case, the display unit 25 displays 11:15 as illustrated in FIG. 16B as the sub-start candidate time corresponding to the development instruction portion 501.

Similarly, when the customer clicks the development instruction portion P502, the display unit 25 displays times in increments of the unit time period from 12:15 to 13:45, as the sub-start candidate times corresponding to the development instruction portion P502. When the customer clicks the development instruction portion P503, the display unit 25 displays times in increments of the unit time period from 14:15 to 14:45, as the sub-start candidate times corresponding to the development instruction portion P503. Note that the unit time period is 15 minutes in the present disclosure.

In the selection screen V6a of FIG. 16B, collapse instruction portions P501a and P501b are displayed to correspond to the portions where the sub-start candidate times are displayed. When the collapse instruction portion P501a or P501b is selected, the display unit 25 displays the selection screen V6 illustrated in FIG. 16A. The display unit 25 cancels display of the sub-start candidate times and the collapse instruction portions P501a and P501b, and displays the development instruction portion P501 in the selection screen V6.

Although the development instruction portion P501 and the like are icons in which an upward arrow and a downward arrow are vertically arranged in FIGS. 16A and B, the present invention is not limited to this. Although explanation is given of the case where the collapse instruction portion P501a is an icon including a downward arrow while the collapse instruction portion P501b is an icon including an upward arrow and these icons are displayed, respectively, above and below a display portion of the sub-start candidate times, the present invention is not limited to this. Moreover, although the case where the start candidate times and the sub-start candidate times are displayed in the list box is explained in FIGS. 16A and B, the present invention is not limited to this. The start candidate times and the sub-start candidate times may be displayed in any way as long as only the start candidate times or the start candidate times and the sub-start candidate times are displayed in response to an instruction of the customer, and one of the times is identified as the reservation start time.

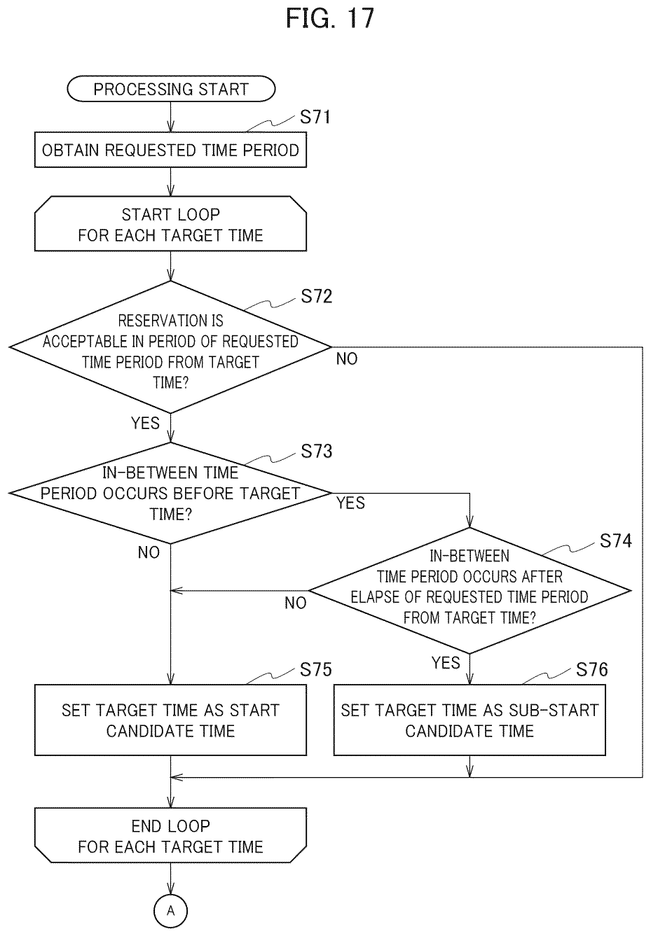

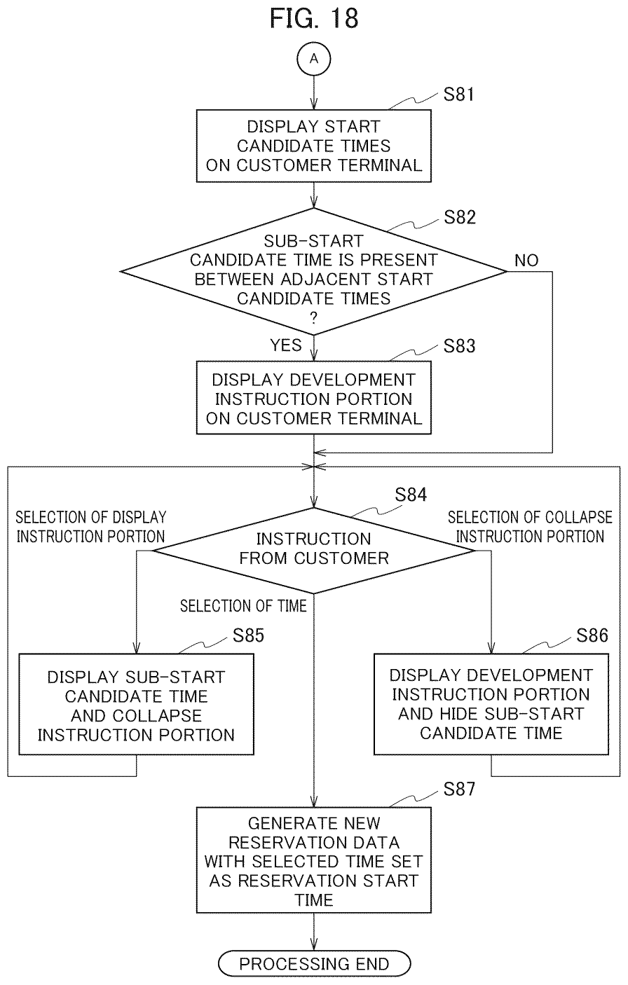

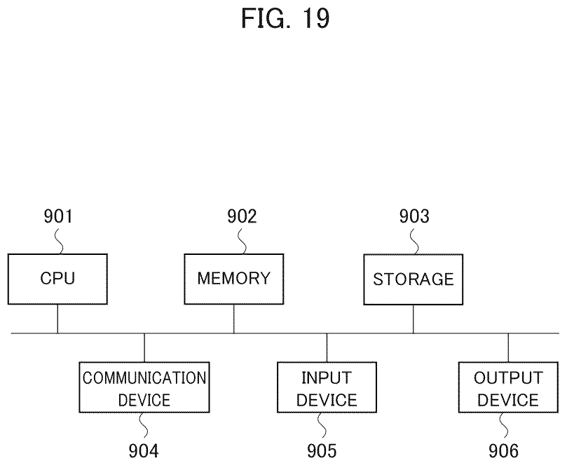

Processing of the reservation assistance device 1 according to the fourth modified example is explained with reference to FIGS. 17 to 18.

In step S71, the reservation assistance device 1 obtains the requested time period and the requested date for which the customer requests to make the reservation.

The reservation assistance device 1 performs processing of step S72 to step S76 for each of target times of the requested date. In this case, the target times are set every unit time period.

In step S72, the reservation assistance device 1 refers to the status data 12, and determines whether or not the reservation is acceptable in a period of the requested time period from the target time. When the period includes the reservation unacceptable time period, the reservation assistance device 1 performs the processing of S72 for the next target time. When the reservation is acceptable, the processing proceeds to step S73.

In step S73, the reservation assistance device 1 determines whether or not the in-between time period occurs before the target time. When the in-between time period occurs, the processing proceeds to step S74. Meanwhile, when no in-between time period occurs before the target time, the processing proceeds to step S75.

In step S74, the reservation assistance device 1 determines whether or not the in-between time period occurs after elapse of the requested time period from the target time. When no in-between time period occurs, the processing proceeds to step S75. When the in-between time period occurs, the processing proceeds to step S76.

In step S75, the reservation assistance device 1 determines that no in-between time period occurs in at least one of the periods before and after the target time, and sets the target time as the start candidate time. Meanwhile, in step S76, the reservation assistance device 1 determines that the in-between time period occurs in both of the periods before and after the target time, and sets the target time as the sub-start candidate time.

When the processing from step S72 to S76 is completed for each target time, the processing proceeds to step S81. Note that, when the reservation is unacceptable for all target times, the reservation assistance device 1 displays this information on the customer terminal 2.

In step S81, the reservation assistance device 1 first displays the start candidate times identified in step S75 on the customer terminal 2. In step S82, the reservation assistance device 1 determines whether or not any of the sub-start candidate times identified in step S76 is present between the adjacent start time candidates. When the sub-start time candidate is present, in step S83, the reservation assistance device 1 displays the development instruction portion on the customer terminal 2 in association with the adjacent start candidate times.

In step S84, when an instruction inputted from the customer terminal 2 is selection of the development instruction portion, the processing proceeds to step S85. In step S85, the reservation assistance device 1 displays the sub-start candidate time between the two start candidate times corresponding to the selected development instruction portion and the collapse instruction portion for hiding the sub-start candidate time, on the customer terminal 2.

When the instruction inputted from the customer terminal 2 is selection of the collapse instruction portion in step S84, the processing proceeds to step S86. In step S86, the reservation assistance device 1 hides the sub-start candidate time corresponding to the selected collapse instruction portion, and displays the development instruction portion.

When the instruction inputted from the customer terminal 2 is selection of the time in step S84, the processing proceeds to step S87. In step S87, the reservation assistance device 1 generates the new reservation data 14 with the selected time set as the reservation start time.

In the fourth modified example, the reservation assistance device 1 first displays the start candidate times at which no in-between time period occurs in at least one of the periods before and after the reservation time period as the reservation acceptable times, and also displays the icon for displaying the sub-start candidate times at which the in-between time period occurs in the periods before and after the reservation time period, on the customer terminal 2. Moreover, the reservation assistance device 1 displays the sub-start candidate times in addition to the start candidate times in response to selection of this icon.

The reservation assistance device 1 displays the sub-start candidate times only after an action performed by the customer. The reservation assistance device 1 can promote the customer to select the start candidate times displayed first. The reservation assistance device 1 can control the start time of the reservation such that no in-between time period occurs.

For example, a general-purpose computer system including the CPU (central processing unit, processor) 901, the memory 902, the storage 903 (HDD: hard disk drive, SSD: solid state drive), a communication device 904, an input device 905, and the output device 906 is used as the reservation assistance device 1 (including the reservation assistance devices 1a and 1b) of the present embodiment explained above. In this computer system, the CPU 901 executes a program loaded onto the memory 902 to implement the functions of the reservation assistance device 1.

Note that the reservation assistance device 1 may be implemented by one computer or by multiple computers. Moreover, the reservation assistance device 1 may be a virtual machine implemented in a computer.

The program of the reservation assistance device 1 may be stored in a computer-readable recording medium such as an HDD, an SSD, a USB (Universal Serial Bus) a memory, a CD (Compact Disc), or a DVD (Digital Versatile Disc) or may be distributed through a network. The computer-readable recording medium is, for example, a non-transitory recording medium.

Note that the present invention is not limited to the above embodiment, and various modifications can be made within the scope of the spirit of present invention.

### EXPLANATION OF THE REFERENCE NUMERALS

1 reservation assistance device
2 customer terminal
3 staff terminal
5 processing system
11 requested reservation data
12 status data
13 setting data
14 new reservation data
15 reservation data
16 staff data
17 notification data
18 start candidate time data
21 obtaining unit
22 proposal unit
23 update unit
24 identification unit
25 display unit
901 CPU
902 memory
903 storage
904 communication device
905 input device
906 output device

1. A reservation assistance device comprising:
a storage device configured to store status data indicating whether or not a reservation from a customer is acceptable for each of unit time periods;
an obtaining unit, including one or more processors, configured to obtain a requested start time and a requested end time of the reservation requested by the customer; and
a proposal unit, including one or more processors, configured to refer to the status data, and when the reservation is acceptable in a period from the requested start time to the requested end time and a difference time period between the requested start time and an end time of a reservation unacceptable time period immediately before the requested start time is equal to or larger than a unit time period and is less than a predetermined time period, output a proposal of changing the requested start time to the end time of the reservation unacceptable time period immediately before the requested start time, to the customer.

2. The reservation assistance device according to claim 1, wherein, when a difference time period between the requested end time and a start time of the reservation unacceptable time period immediately after the requested end time is equal to or larger than the unit time period and is less than the predetermined time period, the proposal unit outputs a proposal of changing the requested end time to the start time of the reservation unacceptable time period immediately after the requested end time.

3. A reservation assistance device comprising:
a storage device configured to store status data indicating whether or not a reservation from a customer is acceptable for each of unit time periods; and
a proposal unit, including one or more processors, configured to refer to the status data, and when a difference time period between a first time period in which the reservation is unacceptable and a second time period in which the reservation is unacceptable and that is immediately after the first time period is equal to or larger than a unit time period and is less than a predetermined time period, propose a change of the first time period or the second time period.

4. The reservation assistance device according to claim 3, wherein, when the reservation is unacceptable in the first time period due to the reservation of the customer, the proposal unit outputs a proposal of changing a reservation end time to a start time of the second time period, to the customer.

5. The reservation assistance device according to claim 3, wherein, when the reservation is unacceptable in the first time period due to a break of a staff, the proposal unit outputs a proposal of changing an end time of the break to a start time of the second time period, to the staff.

6. The reservation assistance device according to claim 3, wherein, when the proposal unit has made the proposal a predetermined number of times or more to the customer who has made the reservation for the first time period, the proposal unit proposes a change of the second time period.

7. The reservation assistance device according to claim 4, wherein the customer is a customer who has answered in advance that a time change is possible.

8. The reservation assistance device according to claim 7, wherein, when the difference time period is reduced or is made to be equal to or more than the predetermined time period by time change contents allowed by the customer in advance, the proposal unit makes the proposal.

9. A reservation assistance device comprising:
a storage device configured to store status data indicating whether or not a reservation from a customer is acceptable for each of unit time periods;
an obtaining unit, including one or more processors, configured to obtain a requested time period of the reservation requested by the customer; and
an identification unit, including one or more processors, configured to refer to the status data and identify, from among start candidate times at which the reservation of the requested time period is acceptable, a start candidate time at which a difference time period between the start candidate time and an end time of a reservation unacceptable time period immediately before the start candidate time is zero or equal to or more than a predetermined time period or a difference time period between a time at which the requested time period has elapsed from the start candidate time and a start time of the reservation unacceptable time period immediately after the time is zero or equal to or more than the predetermined time period; and
a display unit configured to display the start candidate time identified by the identification unit, to the customer.

10. The reservation assistance device according to claim 9, wherein
the identification unit further identifies, from among the start candidate times at which the reservation of the requested time period is acceptable, the start candidate time at which the difference time period between the start candidate time and the end time of the reservation unacceptable time period immediately before the start candidate time is less than the predetermined time period and the difference time period between the time at which the requested time period has elapsed from the start candidate time and the start time of the reservation unacceptable time period immediately after the time is less than the predetermined time period, as a sub-start candidate time, and
the display unit further displays the sub-start candidate time in response to an instruction of the customer.

11. The reservation assistance device according to claim 10, wherein
when the sub-start candidate time is present between two adjacent start candidate times among the start candidate times, the display unit displays a development instruction portion such that the development instruction portion corresponds to the two adjacent start candidate times, and
when the development instruction portion is selected, the display unit displays the sub-start candidate time between the two adjacent start candidate times.

12. (canceled)

13. (canceled)

14. (canceled)

15. (canceled)
